(19) United States
(12) Patent Application Publication
(10) Pub. No.: US 2024/0342628 A1
(43) Pub. Date: Oct. 17, 2024

(54) CONTINUOUS VACUUM DISTILLATION SYSTEM AND METHOD

(71) Applicant: Will Cody Whipple, Reno, NV (US)

(72) Inventor: Will Cody Whipple, Reno, NV (US)

(21) Appl. No.: 18/751,470

(22) Filed: Jun. 24, 2024

Related U.S. Application Data
(63) Continuation-in-part of application No. 17/500,879, filed on Oct. 13, 2021, now abandoned.
(63) Continuation of application No. 18/330,193, filed on Jun. 6, 2023, now abandoned.
(60) Provisional application No. 63/091,190, filed on Oct. 13, 2020.

(51) Int. Cl. B01D 3/14; B01D 3/00; B01D 3/10; B01D 3/32; B01D 3/42

(52) U.S. Cl. CPC B01D 3/143; B01D 3/002; B01D 3/10; B01D 3/322; B01D 3/4233

(57) ABSTRACT

A continuous vacuum distillation system for separating one or more components of a multi-component composition by distillation, including a plurality of distillation columns, including a stripping column and a rectification column, wherein at least some of the distillation columns are configured according to an indirect split arrangement of coupled sections. In some embodiments, a near steady-state pressure condition operating range of 15 mmHg to 85 mmHg is obtained, with an operating temperature of less than 100° F., where the a near steady-state condition includes a nearly unchanged pressure condition across multiple stages. In some embodiments, processing across all stages occurs as a closed system.

### CROSS-REFERENCE TO RELATED APPLICATIONS

This application is a continuation-in-part of U.S. Non-Provisional patent application Ser. No. 18/330,193 entitled “CONTINUOUS VACUUM DISTILLATION SYSTEM AND METHOD” filed on Jun. 6, 2023, which application is a continuation-in-part of U.S. Non-Provisional patent application Ser. No. 17/500,879 entitled “CONTINUOUS VACUUM DISTILLATION SYSTEM AND METHOD” filed on Oct. 13, 2021, which claims priority through the applicant's prior U.S. Provisional Patent Application No. 63/091,190 entitled “VACUUM DISTILLATION SYSTEM AND METHOD” filed on Oct. 13, 2020, which application is hereby incorporated by reference in its entirety.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF DISCLOSURE

The present application relates to methods for rectification of alcohol from an alcoholic mixture. In particular, the application relates to methods for rectifying alcohol comprising, for example, processing fermented feed into high grade distilled spirits in an evaporation apparatus by reducing the pressure within the evaporation apparatus.

### APPLICANTS' VIEW OF SOME ASPECTS OF PRIOR ART

Distillation equipment, including batch and continuous, have existed in many designs for hundreds of years. Historically, distillation occurred in an open (i.e., at least partially open to the atmosphere) system that was not pressure controlled. Packed distillation columns, heat exchangers, kettles, and other components of the system have existed in many forms for many years. Distillation of spirits at atmospheric pressure was historically used for rectification of alcohol for beverages. Distilling at atmospheric pressure typically involved obtaining high temperatures to boil products, which often resulted in problems and disadvantages. For example, high heat input rates typically used for high temperature kettles often scorched products, produced unwanted flavors, or both. Processing and distilling fermented feeds at elevated temperatures typically caused reactions that altered the character of the distillates collected. Increased temperature often further caused increased reaction rates in typical organic aqueous systems. Further, alcohol at high temperatures can be dangerous, sometimes resulting in a need for process control and safety control measures to mitigate hazards created by, among other things, the high temperature and high-risk nature of these historical processes. This can introduce complexity, cost, or both to the distillation process. High temperatures during processing of the wash (i.e., feed) and subsequent distillate products often degraded flavors, quality of the spirits produced, or both.

Existing vacuum distillation systems are generally small and cumbersome, often built for laboratory operations. These existing systems are typically not feasibly operable or scalable for production operations. Batch vacuum systems such as these often require much more labor per gallon distilled and are not capable of the larger production quantity outputs that would be required in today's markets.

### BRIEF SUMMARY OF SOME ASPECTS OF THIS SPECIFICATION

The continuous vacuum distillation system and method involves continuous (steady state) processing of fermented feed into high grade distilled spirits. Fermented feed is distilled under reduced pressure to achieve a lower operating temperature during processing. Reduced temperature distilling where material is heated below ambient temperature can create more desirable flavors, reduced harshness, or both, in distillates. In some embodiments, fermented beverages use varieties of yeast, such as, for example, Saccharomyces cerevisiae, to produce alcohol. These yeast varieties can produce a wide range of by-product compounds in addition to ethanol. These compounds include, but are not limited to, esters, ketones, acetaldehydes, sulfur compounds, fusel alcohols (longer carbon chain than ethanol), organic acids, fatty acids, and terpenes. Many of these compounds are reactive and not stable when heated. Processing and distilling fermented feeds at reduced temperatures can reduce or eliminate reactions that alter, including negatively alter, the character of the distillates collected. Decreased temperature can reduce the reaction rate in typical organic aqueous systems as compared to high temperature systems. Lower temperatures during processing can further reduces or eliminate unwanted side reactions that can occur during the distillation process.

The continuous vacuum distillation system and method can reduce or minimize the production of unwanted compounds, including, for example, degraded or destroyed terpenes or esters. Off-flavors can be formed when heating fermented beverages. The off-flavors formed during the distillation process can be minimized or eliminated by, at least in part, controlling the pressure of the process in a closed system, therefore reducing the processing temperature of the distillation across some, most, or all of the processing system. In some embodiments, the continuous processing of feed material reduces energy input, increases efficiency of the operation, or both. The continuous vacuum distillation system design and continuous operations ability can allow for one or more of automated operation, improved product quality and control, lower utilities requirement (e.g., cooling, heating, electricity, and the like), smaller equipment footprint, lower system capital cost, reduced process risk, and reduced labor requirements compared to existing spirits distillation technologies.

The nature of the continuous processing of the system can reduce energy input compared to the requirement of batch distillation, which involves additional condensing of the stripped liquid and transport of the liquid to further downstream processing. The indirect split arrangement of the columns, as compared to direct spit, where the heads, hearts, and tails are separated in and after the stripping stage, storage of the liquid, an arrangement that removes heads first and then tails rather than tails first, then heads, can further reduce energy input by reducing certain evaporation and condensation steps in the coupled sections that allow for continuous processing.

The operational temperature of the system, as compared to non-pressure-controlled systems that operate at ambient pressure, can also reduce energy loads as the material does not require preheating before entering the stripping column. Many traditional designs required a feed heater or additional equipment to recuperate heat from the overhead products into the feed, requiring more equipment and capital expenditure. The cold operating temperature, which can be less than 100° F. at the hottest point in the system, namely, stripped bottoms liquid, can reduce process risk due to elevated temperature processing. In some embodiments, operating temperature of the system and the take-offs of the flammable spirits products is below ambient temperature of the room/environment. This can reduce risk of fire/explosion due, at least in part, to the vapor pressure of the flammable liquid being reduced at the reduced temperature. Burn risks can also be reduced as the hot components of the system capable of causing burn injury can be limited to the reboiler heating media(s).

In some embodiments, due at least in part to the reduced temperature of the process, reboiler heat may be supplied at a much lower level, such as, for example, less than 110° F. This can allow for new heat sources, such as renewables, solar hot water, geothermal, and the like, to be used for the process, which can reduce carbon footprint and energy waste.

The nature of the vacuum pressure in the system during operation can also reduce risk. If a leak does develop, air leaks into the system instead of flammable liquid or vapor leaking out of the system. Pressure sensor control integrated with the vacuum system and vacuum pressure control valve can sense excess air leakage into the system and stop processing so that the issue may be remedied.

One or more of integrating the stripping, rectification, and heads removal sections can, allow for continuous operation of one system to produce high-quality spirit. The coupling of the system and continuous operation can allow for the product to move through processing without being re-heated or cooled or re-condensed or evaporated as is necessary in batch processing when the product is moved from a stripping still to a fractionating still that would make separations cuts of the components. The continuous nature of the process can allow for a greater product processing capability than that of batch systems of equivalent capital cost. Batch distillation systems require much larger spaces and typically multiple stills to match the production output of this continuous system. The cold processing temperatures that the product is exposed to can prevent unwanted degradation of flavors/compounds or formation of unwanted flavors/compounds in distillate products.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to best explain the principles of the present systems and methods and their practical applications, to thereby enable others skilled in the art to best utilize the present systems and methods and various embodiments with various modifications as may be suited to the particular use contemplated.

In some embodiments the system may utilize a refrigerant heat pump system to supply process heat to one or more reboilers, supply process cooling to one or more condenser, or both. Due, at least in part, to the vacuum conditions, lower operating temperature, or both, the lower quality heat requirement of the reboiler(s) in the system can be well suited to typical refrigerant operating pressures and temperatures, whereas a normal atmospheric still/system typically demanded higher quality heat and required more extreme-tolerant equipment, refrigerants, or both, to operate a heat pump system.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a block flow diagram of a basic arrangement;

FIG. 1B is a block flow diagram of an arrangement with additional tails and heads columns;

FIG. 2 block flow diagram of a basic arrangement with reboiler;

FIG. 3 is a block flow diagram of liquid off-take;

FIG. 4 is a block flow diagram of an arrangement with multiple rectification column sections and optional column configured as vertically integrated system;

FIG. 5 is a block flow diagram of an arrangement with multiple rectification column sections and column configured as side stripper;

FIG. 6 is a block flow diagram of an arrangement with multiple rectification column sections and additional rectification column with pumped reflux and column configured as side stripper;

FIG. 7 is a block flow diagram of an arrangement with multiple rectification column sections and additional rectification column with pumped reflux and column configured as side stripper and optional column section;

FIG. 8 is a block flow diagram of an arrangement with multiple rectification column sections and additional rectification column with pumped reflux and column configured as side stripper and optional column configured as a side stripper;

FIG. 9 is a block flow diagram of an alternate stripping section arrangement for feed containing solids;

FIG. 10 is a block flow diagram of an alternate stripping section arrangement for feed containing solids with multiple stages;

FIG. 11 is a block flow diagram of an alternate stripping section arrangement for feed containing solids utilizing one steam eductor injection and recirculation loop.

FIG. 12 is a block flow diagram of an alternate stripping section arrangement for feed containing solids utilizing two or more steam eductor injection and recirculation loops.

FIG. 13 is a block flow diagram of a system with an added packing section above the stripping section to act as a demister, de-foaming mechanism, and first rectification section.

FIG. 14 is a drawing of a system utilizing 4″ and 2″ diameter columns.

FIG. 15 is a block flow diagram of a basic equipment arrangement utilizing a heat pump for process heating for one or more reboilers and cooling for one or more condensers for a distillation column or columns.

### DETAILED DESCRIPTION OF SOME EMBODIMENTS

In some embodiments, the continuous vacuum distillation system is sized based, at least in part, on alcohol feed rate (i.e., the absolute amount of alcohol in feed) that, in some instances, can be between 1% alcohol by volume to upwards of 10% alcohol by volume. In other instances, the feed rate can be between 10% alcohol by volume and 50% alcohol by volume. In still other instances, the feed rate can be between 40% by volume and 90% by volume. Lower alcohol feeds can eventually limit the operation of the stripping column operation due, at least in part, to increased amounts of liquid in very low levels of alcohol by volume. The continuous vacuum distillation system operates within an operating window, including an acceptable feed rate range coordinated with a set of control parameters that, in combination, facilitate the correct loading of columns and generation of outputs according to specifications. In some embodiments, the continuous vacuum distillation system is about a 4″ diameter column system that operates on or about a 6 gallon per hour feed rate. In some instances, the continuous vacuum distillation system can be operated in a feed range of 6 gallons per hour to 20 gallons per hour with an 8% alcohol by volume feed. In other instances, a lower feed range can operate with higher alcohol by volume feed. In some embodiments, the continuous vacuum distillation system can be operated in a feed range of 6 gallons per hour to 20 gallons per hour with an 8% alcohol by volume feed. In other instances, the continuous vacuum distillation system can be operated at 16 gallons per hour. In other instances, the continuous vacuum distillation system can be operated at 180 gallons per hour, with, in some instances, about a 50% feed rate minimum.

In some embodiments, the maximum temperature specification of the continuous vacuum distillation system will be determined based, at least in part, on feed material, desired product, or both. For example, traditional grain fermentations produce acceptable products below 100° F. and typically preferred products below 90° F. In some instances, maximum temperature will be between 70° F. to 100° F., where such temperature may be seen at the bottom of the first column (stripping column). A pressure drop specification across the system will, at least in part, determine the target pressure at the first column, which pressure, at least in part, will determine the temperature. In some instances, the continuous vacuum distillation system operates in a steady-state condition, or near steady-state condition, where the pressure drop will be unchanged, or nearly unchanged, across all or most stages and components of the system. Operation pressure specification will influence, at least in part, the pressure drop and the temperature across various stages in the continuous vacuum distillation system; as operating pressure is lowered the density of the vapor decreases and causes larger vapor volume flow rates and therefore increased velocities. Equipment sizing (column diameter and piping size) increases with lower operating pressure to ensure that pressure drop across the system does not exceed the pressure specification.

In some embodiments, feed temperature range is close to the stripping column top operation temperature, in part, to avoid the loss of alcohol through the bottoms of the column the reduction of overall extraction efficiency, or both. In some instances, the feed temperature is at within about 10° F. of the top operating temperature of the stripping column. In some instances, the feed temperature is within about 2° F. of the top operating temperature of the stripping column. Maintaining a temperature below the top operating temperature, at least in part, prevent the feed from flashing in the piping and the reduction of the accuracy of the flow meter, which can otherwise cause surging flow into the column that can be mal-distributed in the packing, which can result in lower extraction efficiency or even carryover of material overhead to the next column through the vapor piping.

In some embodiments, a feed control valve is downstream of feed flowmeter, at least in part, to avoid the flashing of liquid, which can cause disruption of the flowmeter reading and inaccuracy, which in turn, could result in disturbances in the downstream operations, such reflux interruption and rectification disruption. A feed pump can provide pressure so that the liquid flows at an acceptable rate through the feed piping while also helping to ensure that the pressure remains above the vapor pressure of the feed liquid in the piping to, at least in part, avoid flashing that can contribute to inaccurate feed measurement.

In some embodiments, system pressure is measured by a pressure sensor at the inlet of the furthest downstream condenser, which can be used as a reference as the lowest temperature in the distillation vapor path. Pressure is maintained in the closed system as vapor is removed at a controlled rate via a control valve. In some embodiments, system operation temperature is in the range of 60° F. to 100° F. which corresponds to an absolute pressure operating range of approximately 25 mmHg to 55 mmHg. In some instances, an absolute pressure operating range can be approximately 15 mmHg to 85 mmHg.

In some embodiments, the stripping column reboiler operates to vaporize at least a portion of the column bottoms liquid to provide heat for stripping alcohol vapor overhead. The mass flow rate of the liquid recirculated through a reboiler that is pumped (as opposed to a smaller stab-in style reboiler on smaller systems) can be at least 5 times the vaporization rate to, at least in part, help to ensure that the product is not exposed to high temperatures. In some instances, it is 10 to 20 times the vaporization rate. Higher recirculation rates can be achieved, at least in part, using larger plumbing, larger heat exchangers, pumps, and the like. Stab-in reboilers (on smaller systems, such as 4″ column system) can be used for applications that do not have solids in the feed, though the heat transfer surface/element is likely submerged under the liquid and the surface area of the element increased or maximized. In some embodiments, low watt density heater elements are used (<150 Watts/inch²), or ultra-low watt density heater elements are used (<50 watts/inch²). The heat input to the reboiler can be adjusted such that 90% or more of the total alcohol is vaporized. With a stable system and known feed properties, the bottoms temperature of the stripping column can be utilized to adjust reboiler input heat setting to obtain an extraction efficiency range target.

In some embodiments, operation of the rectification column is controlled, at least in part, by the heat input to the bottom of the column, such as from the vapor coming from the overhead of the stripping column, or by the combination of the vapor from the stripping column and an optional reboiler at the bottom of the rectification column, and by the reflux ratio of the overhead product of the column. The overhead product of the rectification column is completely or nearly completely condensed, except for some non-condensable compounds such as carbon dioxide, methanol, acetone, and the like, some or all of which are system design and feed dependent, into liquid. This liquid is collected in an overhead separator and partially returned to the top of the active packing in the column using a reflux pump. For lower proof spirits, such as 120 to 160 proof, the reflux ratio may be in a range of 0.1:1 to 1:1 (10% of the liquid returned to column to 50% of the liquid returned to column). For higher proof spirits, such as 160 to 189 proof, the column can operate with a reflux ratio of 1:1 to 2:1. A higher reflux ratio can cause the system to shift to higher output proof. For the highest proof spirits (190 and above), reflux ratios of 1.5:1 and higher can be used.

In some embodiments, the separators have similar designs with an overflow baffle that is constructed on the inside. This can fill the first compartment with liquid and have the remaining liquid overflow to the second compartment. A pump on the first compartment can be set at a desired reflux return rate to the column. In some instances, this pump is a diaphragm pump that can be adjusted for rate control. The pump on the second compartment may be a diaphragm pump that is set to pump off all remaining liquid. A high-level switch on the separator can help to ensure that the vapor path is not blocked by liquid in the system and alerts an operator to check the system or pumps for issues. This arrangement allows for precise control of the reflux without additional level transmitters, flow transmitters, or sensors that can otherwise increase the cost of the system. The Separator may also be placed above the column and the second pump may be eliminated, where secondary overflow would gravity flow to the destination column feed.

In some instances, the condensers are designed for low pressure drop, full condensation, and for reduced sub-cooling. The system can be one of shell and tube heat exchangers; one arrangement that allows for reduced or minimal subcooling is to have the vapor side of the heat exchanger outside the tubes, allowing for the condensing liquid to collect and fall off of the tubes, collecting in the lower area of the shell and moving to downstream piping with reduced or minimal contact time with the tubes (glycol can flow inside the tubes in this arrangement). The reduced or minimal contact time with the liquid and heat exchange area can cool the liquid to less than 10° F. below the dew point of the vapor. In some instances, The reduced or minimal contact time with the liquid and heat exchange area can cool the liquid to less than 1-2° F. The reduced or minimally cooled reflux can allow for increased efficiency in the separation in the packing, as the active packing area where the rising vapor and falling liquid have closer temperatures to their bubble points/dew points.

In some embodiments, liquid takeoff for the continuous vacuum distillation system is arranged such that it allows for one or more of in-line sampling of all off-take products, inline pump take-off of each product if desired, and for the typical waste products to be safely blended together and pumped out of the closed system with just one pump instead of additional pumps for additional products. This can reduce capital investment, reduce energy waste due to reduction of the number of pumps operated, or both. Liquid overflows in the sumps of each column can be piped to a common liquid take-off tank. The columns have stand-pipes that extend vertically to the normal operating level of the sump. This helps prevent, at least in part, the sump liquid from moving into the offtake system and creating a low level in the sump. Level can be controlled in the sump of each column in this fashion, or alternatively pumped from each sump with a pump and controlled by level controlling instrumentation for each sump. Stand-pipes for each line routed to the liquid take off tank also have stand-pipes that extend vertically to the maximum or near-maximum operating level of the liquid take off tank. Lines that extend from the sumps enter the common collection vessel and have a stand pipe extended on the interior of the vessel. This can prevent the liquid in the take-off tank from being siphoned back into the column sumps. Each pipeline has a low point elevation that is specified, such as 6″, 12″ or more from the top of the stand pipe. This arrangement creates a vapor trap that does not allow vapor to be cross-exchanged through piping intended for liquid between the columns and collection vessel. The liquid take off tank can be vented to the sump of the stripping column, as vapors from the tank are recycled to the first column. Sample valves or pump take-offs can be installed on the liquid lines routed to the take-off tank upstream of the vapor trap low points in the piping. This arrangement results in the liquid levels in the sumps being set by the height of the stand pipes, and they overflow into the collection vessel continuously as the liquid collects in the sumps. In some embodiments, there is a stand pipe on each end of each line from the sumps to the common vessel.

In some embodiments, the heads stripping column operates in a similar fashion to the first stripping column. Reboiler heat is applied to vaporize column bottom contents in a gentle fashion not to impart any excess high temperature. Circulation rates and vaporization rates can be the same. The column diameter can be smaller as the overhead product of this column as a fraction of its feed is much smaller than the first stripping column. In some instances, the heads stripping column can be sized to remove 1% to 20% of the incoming feed by fractionating in one of two modes, with reflux or without.

In some instances, a batch kettle may be tied into the system in order to utilize the first or second condensers and collection vessels for multiple purposes, rather than having a dedicated condenser and collection system for a batch system. The tie-in point can be upstream or just upstream of the first condenser. Isolation valves for the piping upstream of connection point near this condenser may be employed in order to reduce exposure, to reduce or minimize equipment that requires cleaning after batch run, or both.

In some embodiments, a heat pump provides process heating and cooling for the continuous vacuum distillation system. In some implementations, a refrigerant heat pump circuit is arranged such that a compressor supplies the high-pressure circuit that is routed to one or more reboilers for the continuous vacuum distillation system. These reboilers can act as condensers for the refrigerant system as they heat the process. Excess heat generated by the compressor itself can be removed from the refrigerant system on the high-pressure side by means of a heat exchanger, such as, for example, an air cooler on the high-pressure side. The air cooler can be controlled by, for example, one or more variable speed controllers, one or more on/off controllers for fan motors, or both via a refrigerant temperature or a pressure setpoint. In some embodiments, other sources of cooling are used as the cold sink for the heat exchanger as well including liquid or vapor process streams with temperature below the high side reboiler operating temperature. In some instances the condensed refrigerant from the one or more process reboilers and one or more excess heat exchanger is routed to the one or more process condensers where a refrigerant let-down valve or valves modulates to allow the refrigerant into the refrigerant side of the one or more heat exchanger that is the condensers. As the refrigerant expands from liquid to vapor downstream of the one or more letdown valves, it cools the system, removing heat from the process vapor as it condenses to liquid. The evaporated refrigerant can be routed back to the compressor where it can begin the heat pump cycle again. In some implementations, the refrigerant high and low pressure sides operating pressures can be independently controlled so as to maintain desired temperature or temperatures for the process heating, cooling, or both. The heat pump system may be adjusted in operating pressure on the high side, low side, or both by adjusting one or more of setpoints of the compressor discharge target, the setpoint of the excess heat exchanger, and the target pressure of the refrigerant letdown valve. In some instances, this method of adjustment is determined, at least in part, by system volume. The refrigerant inventory in the system can be adjusted to adjust the operating pressure of the high side, low side, or both, of the heat pump system. This can be carried out by removing refrigerant, adding refrigerant, or both, to the continuous vacuum distillation system with one or more refrigerant pumps, one or more standby refrigerant storage vessels, or both. Moving refrigerant out of the heat pump system can lower its inventory, operating pressure, or both, and the resulting temperature. Adding refrigerant inventory to the heat pump system can increase its operating pressure and the resulting temperature. The addition of the heat pump to the system can reduce or eliminate other means of heating for the one or more reboilers, such as steam heating, as well as reduce or eliminate other means of cooling for the one or more condenser, such as glycol cooling. This eliminate or reduce the use of auxiliary equipment for operation including, for example, other sources of process heat, such as a steam boiler, other source of process cooling, such as a chiller, or both. The addition of a heat pump for process heating, cooling, or both can lower the overall utility (e.g., process heating and cooling) energy input to the continuous vacuum distillation system for processing.

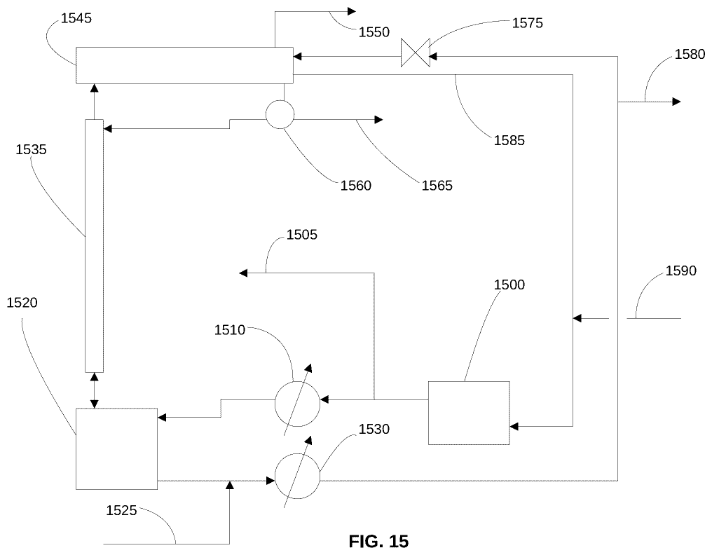

Referring now to FIG. 15, in some embodiments, the compressor 1500 supplies pressurized refrigerant to reboiler 1520, and in some implementations to one or more additional reboilers via the pipeline 1505. Heat exchanger 1510 can be an air cooler or other heat exchanger for removing excess heat from the refrigerant compressor discharge. In some instances heat exchanger 1530 is an alternate location. In others instances heat exchanger 1530 is an additional heat exchanger for surplus heat removal from the refrigerant system. Pipeline 1525 is a refrigerant return line from one or more optional additional reboilers. Column 1535 is a distillation column that is supplied vapor from reboiler 1520 and returns reflux to reboiler 1520. In some instances, vapor from column 1535 enters condenser 1545 where it is condensed by refrigerant entering the system expanding from liquid to vapor state. In some embodiments, refrigerant let-down control valve 1575 allows a rate controlled expansion that can also be controlled to maintain downstream refrigerant pressure in the evaporation coil of the condenser. Pipeline 1550 leaves the condenser and can carry non-condensable vapors downstream to the next component in the system. Reflux controller 1560 splits the condensed liquid stream from the condenser to the column 1535 for reflux, and to the pipeline 1565 to the next equipment. Pipeline 1580 can carry pressurized liquid refrigerant to any other process condensers in the system. Pipeline 1585 can carry expanded refrigerant vapor to the compressor 1500 suction Pipeline 1590 can carry expanded refrigerant vapor from any other process condensers in the process to join pipeline 1585 to the compressor suction.

The continuous vacuum distillation system includes an arrangement of one or more columns, condensers, reboilers, separators, column internals, and other components. The components are selected, designed, constructed, and assembled to obtain and maintain low pressure drop targets for vacuum distillation. In some embodiments, one or more of the columns, packing, liquid distributors, vapor distributors, reboilers, condensers, reflux controllers, piping, controls, and other components are sized, constructed, or specially selected to address the demands of vacuum distillation.

While some usable components are commercially manufactured and available for purchase for general distillation and to obtain cooling demands of general industry, in certain instances, non-standard shell and tube heat exchangers are incorporated to achieve improved performance, by, at least in part, lowering the components pressure drop, and therefore the system's overall pressure drop. Non-standard shell and tube heat exchangers such as those required for some embodiments include features such as shell side vapor cooling to maximize the surface area of the heat transfer area with lower a lower heat transfer rate (vacuum side), large cross-sectional vapor pass areas for reduced pressure drop, enlarged vapor inlets to obtain reduced pressure drop, and tube and tube sheet spacing and/or arrangements to obtain reduced pressure drop. In some embodiments, reboilers with pumped liquid flow are used. In some implementations, smaller systems, such as those with low heat input requirement, thermosiphon reboilers (either internal or external) are used. In some embodiments, temperature of heating media (e.g., steam, hot water, hot oil, or the like) is controlled to within a degree. In other implementations, the temperature of heating media (e.g., steam, hot water, hot oil, or the like) is controlled to within a few degrees. In some embodiments, higher liquid recycle rates are used for higher temperature heating media to, at least in part, assist in limiting heat exchanger surface temperature, liquid film temperature, or both to help prevent product degradation.

In some embodiments, the continuous vacuum distillation system includes multiple distillation columns and heat exchangers intertied by liquid and vapor piping assembled as an apparatus that continuously or near-continuously produces a desirable distillate product, referred to as ‘hearts’, and several other distillate products that are undesirable and separated. Hearts are typically the most desirable fraction of the alcohol separated and are a middle cut of the alcohol distillate.

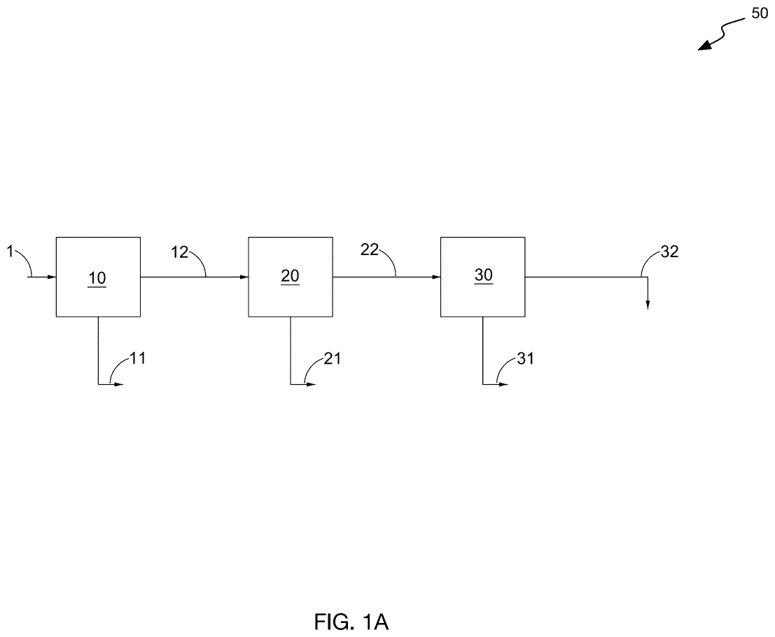

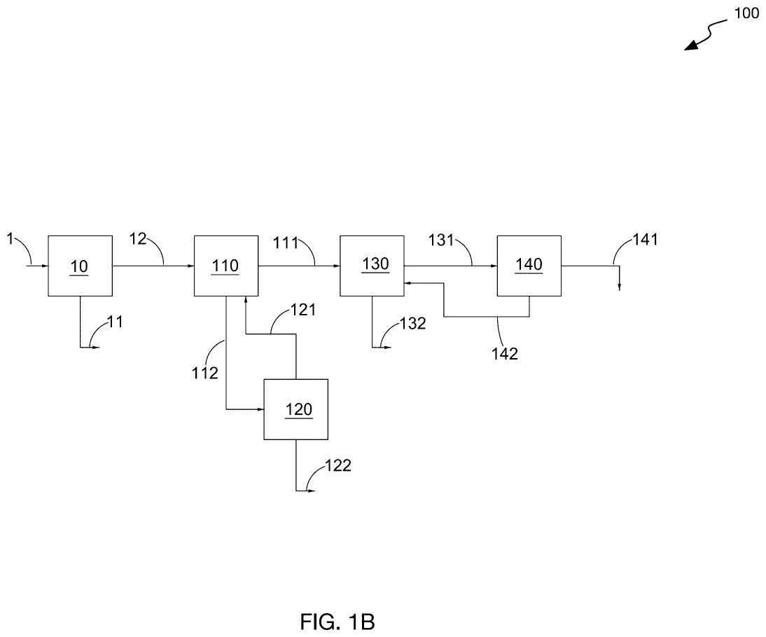

Referring now to FIG. 1A, in some embodiments, components of the system make up several ‘stages’ of separation. In some instances, the first stage, stripping section 10, involves the stripping of the alcohol content of the feed 1. In this stripping section 10, alcohol is separated from the feed. The alcohol separated is a mixture of the desirable and undesirable components and moves to the next stage as a vapor 12. This occurs in, for example, a stripping column or other stripping evaporation apparatus, where the majority, and sometimes up to or exceeding ninety-eight percent, of the alcohol in the feed with a portion of the water content is evaporated and, in some instances, this vapor is routed to the next distillation column 20. The stripped feed leaves the system as bottoms 11. The next distillation column may be configured as the rectification section to increase the fraction of alcohol and purity of the product as desired. The vapor, which includes the evaporated alcohol from the stripping section, can be rectified to desired proof and separated from ‘tails’ or ‘cogniners’ 21 in this second stage or column of the distillation apparatus. ‘Tails’ typically refers to the industry standard term for the heavier cut of the alcohol distillate, containing heavier alcohols or fusel alcohols/cogniners. The vapor product of the second stage can be fully condensed and partially refluxed or partially condensed and partially or fully refluxed into the second column or stage. The remaining condensate and vapor from the second stage can be transferred to a third stage of the apparatus. In some embodiments, the third stage can be transferred to a third stage of the system 30. In some embodiments, the third stage separates the lighter components (heads) 32 from the liquid distillate of the second stage 22 by means of stripping. Overhead condensate may be partially returned to the third stage as reflux. Product (hearts) 31 is recovered at the bottom of the third stage.

The continuous vacuum distillation system can be configured in several different ways, each configuration varying to some degree in arrangement due to, for example, available installation height or other requirements. Additional rectification columns, stripping columns, or column sections can be added to the rectification, third stage (lights removal section), or both, to, among other things, increase product recovery efficiency. In some embodiments, columns are arranged to accommodate installations that are height restricted by being arranged side by side with connecting vapor and pumped liquid reflux piping, or in a vertically integrated fashion.

Referring to FIG. 1B, in some embodiments, stripping sections that recycle desirable product alcohol back into the respective rectification section, lights removal sections, or both are included to, at least in part, increase the yield of the desired hearts product. Rectification column 110 includes an additional bottoms stripper 120 to increase yield of desirable product. Undesirable bottoms product 122 with high concentration of tails is removed from the system. Liquid bottoms product 112 from column 110 is fed to the top of column 120; heat is applied in a reboiler in the sump and the separation yield of desirable product is increased. Vapor 121 from column 120 is routed to the sump of column 110 and joins vapor from the stripping section in the rectification column. The condensed liquid top product 111 from the rectification column is stripped of lights in column 130 and separated into the bottoms product 132 and vapor product 131 that is routed to column 140. This column is an example of a side stripper to increase the yield of the desirable distillate product by reducing bleed over in the lighter cut 141. Liquid bottoms stream 142 is routed back into column 130.

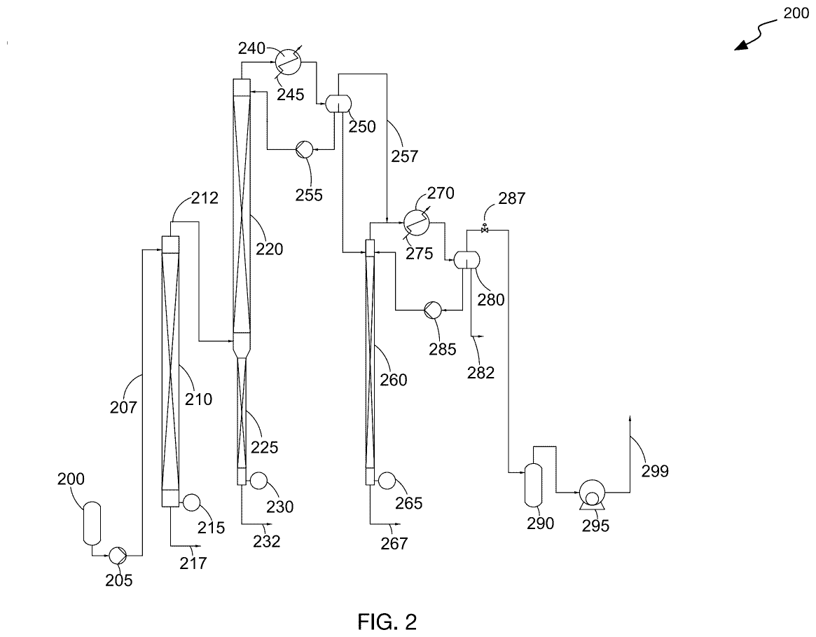

Referring to FIG. 2, in some embodiments, feed is metered from tank 200, using pump 205 into the top of column 210, the stripping column. In some instances, if the liquid head height to the stripping column feed is appropriately arranged, the vacuum of the system may be used to draw feed into the system through pipeline 207, where the rate may be controlled via a proportional valve. The liquid feed can be evenly distributed onto the top of the packed column. In some embodiments, liquid distribution is determined by the specific structured or random packing type and material of construction. Liquid distribution to obtain proper wetting of the packing can be employed, as column efficiency would be reduced with poor liquid distribution across the area of the column-packed bed. The liquid can be distributed by, for example, a spray nozzle or a liquid distributor. In some instances, liquid distributors can be one or more of self-draining, clog-resistant, and designed for flashing feed. In some embodiments, the packed column uses properly sized random packing, structured packing, or grid tray packing(s) able to obtain one or more of the pressure drop, liquid loading, vapor loading, and HETP (height of each theoretical plate) levels for the system.

In some instances, materials of construction for the packing meet materials of construction requirements for the method of CIP (i.e., clean in place), chemicals used, or both. In some embodiments, stainless steel, 304 or higher grade is used; while copper may be used in some instances for its advantageous liquid wetting properties, ability to run lower column liquid rates with higher efficiency where the corrosion rate of the packing is considered with the CIP chemicals being used and inspections occur on regular intervals, or both. In some instances, copper is used in the top of the packed columns to aid in reduction of sulfur compounds produced by the wash.

In some embodiments, the liquid feed moves downward through the packed column as vapors from the reboiler rise, stripping alcohol into the vapor phase. When the liquid reaches the bottom of the column, the majority, and sometimes up to or exceeding ninety-eight percent, of the alcohol has been vaporized. In some instances, the bottom of the column includes a liquid sump with a reboiler. The reboiler can provide energy for vaporizing the liquid in the bottom of the column that drives the alcohol into the vapor phase and into the column overheads. In some embodiments, the reboiler heat input may be facilitated by the injection of live steam into the system, such as the column sump or bottom stage of the column, the steam being ‘clean’ steam and suitable for use in a food-grade process.

In some embodiments, the reboiler is designed specifically to support the vacuum distillation process. Overall pressure drop of the reboiler is minimized to, among other things, control the overall temperature rise of the material as it passes through the reboiler and partially flashes (i.e., evaporates). In some instances, if the reboiler apparatus develops restriction as the large amount of vapor forms, the temperature can rise as the boiling point rises with the pressure that the material in the processing system is exposed to. Stab in reboilers may be used for smaller systems; systems with small enough heat input requirement that an appropriately sized reboiler may be installed inside the column itself.

In some embodiments, steam, hot water, electrical elements, hot oil, or other heating mediums may be used, though in some instances, the temperature differential between the reboiler liquid and the heating medium is kept to less than 150° F. Higher temperatures can demand higher reboiler liquid feed rates to minimize one or more of overheating of the liquid, scorching, and hot spots. Due, at least in part, to the low density of vapor formed in the reboiler operating under vacuum conditions, the vapor rates can be high; one or more of pressure drop, flow arrangement, operating height relative to the column sump liquid level, and return piping (if applicable to the reboiler arrangement) are facilitate proper reboiler operation.

Stripped liquid in the reboiler that has no or nearly no alcohol content is typically referred to as bottoms. The bottoms can be removed from the sump by, for example, an overflow with a liquid trap or by a pump. In some embodiments, the bottoms are routed to the liquid offtake system. The overhead vapor product of column 210 includes the stripped alcohol and may include some water content; the water content varies and can be a function of one or more of the alcohol content of the feed, feed rate, the temperature of the feed, and reboiler 215 heat input rate. The overhead vapor 212 from column 210 is routed to column 220, the rectification column. Bottoms 217 are removed from the system. Column 225 provides for higher efficiency of desired product separation by further separating tails 232 from the system with heat provided by reboiler 230. Overhead vapor is routed to condenser 240 and is cooled using cooling media 245. Liquid is collected in separator 250 and partially returned as reflux using pump 255. Separator 250 is vented with vent line 257 connecting to the inlet of condenser 270 that coles overhead vapor from column 260 using cooling media 275. Reboiler 265 provides heat for column 270 and product 267 is removed from the system. Liquid from condenser 270 is collected in separator 280 and partially returned to column 260 by pump 285. Lights product 280 is removed from system on the downstream side of the separator 280. Valve 287 regulates vapor flow to control system pressure.

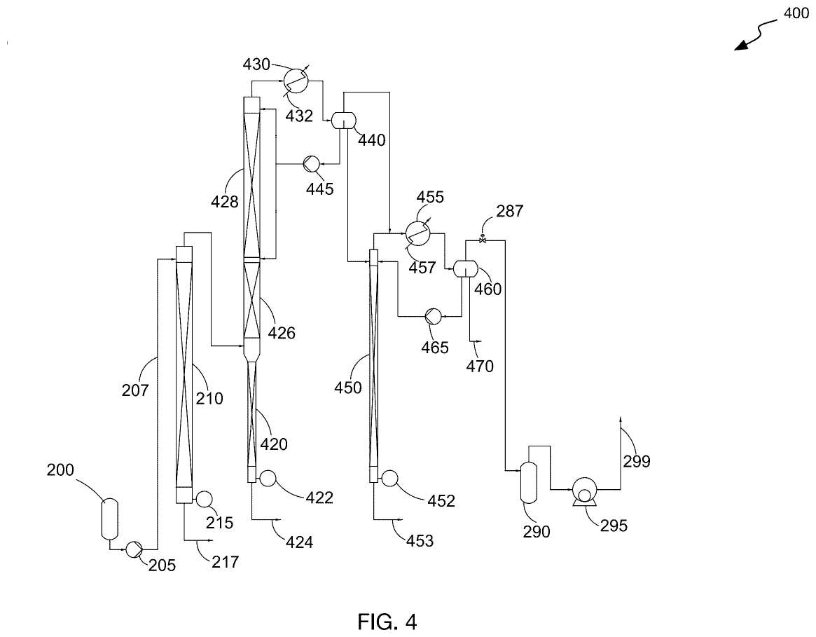

Referring now to FIG. 4, vapor from the stripping column is routed to the column 420, column 426, and column 428. Heat is supplied by reboiler 422 and tails are removed in stream 424. Overhead vapor is routed to condenser 430 and cooled by cooling media 432. Liquid from condenser 430 is collected in separator 440 and partially returned as reflux using pump 445 to either column 428 or to column 426 depending on rectification requirement. Liquid from separator 440 gravity flows to column 450. Reboiler 452 provides heat for column 450 and desirable product is removed at stream 453. Column 450 overheads are routed to condenser 455 and cooled using cooling media 457. Liquid is collected in separator 460 and partially returned to column 450 by pump 465. Light product is removed from the system in stream 470.

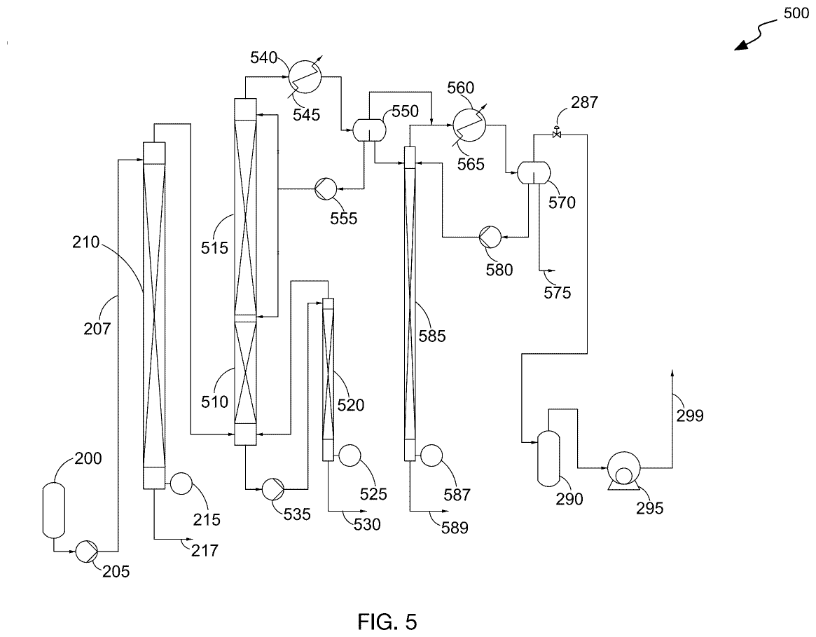

Referring now to FIG. 5, vapor from the stripping column is routed to column 510 and 515. Pump 535 moves liquid from the bottom of column 510 to column 520. Reboiler 525 provides heat for column 520 and stream 530 is a takeoff for tails product. Vapor from column 515 moves to condenser 540 where it is cooled by cooling media 545. Liquid is collected in separator 550 and partially returned to column 515 by pump 555. Remaining liquid is gravity fed to column 585 where it is stripped using heat from reboiler 587. Stream 589 is a takeoff for desirable hearts product. Condenser 560 utilizes cooling media 565 to condense overhead product of column 585. Liquid is collected in separator 570 and partially returned to column 585 using pump 580. Remaining liquid is taken off via stream 575 as the light product.

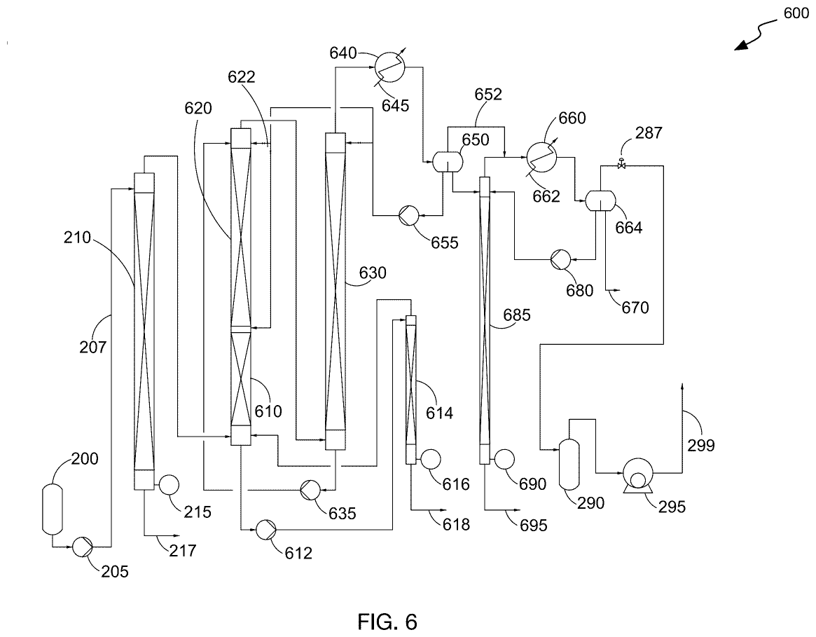

Referring now to FIG. 6, vapor is routed from the stripping column to the column 610, 620, and 630 for rectification. Valving at reflux tee point 622 determines where the reflux is sent and which packing sections are active; more active sections will rectify the product to a higher proof. Pump 635 moves liquid from column 630 to column 620. Pump 612 moves liquid from column 610 to column 614. Reboiler 616 provides heat for separation in column 614 and liquid takeoff 618 provides removal of tails from the system. The system utilizes condenser 640, cooling medium 645, separator 650 and reflux pump 655 for operation. Vent line 652 ties in separator 650 to the inlet of condenser 660 that uses cooling media 662 to condense overhead product from column 685. Reboiler 690 provides heat for column 685 and stream 695 is a liquid takeoff for desirable hearts product. Separator 664, pump 680, and stream 670 handle liquid from condenser 660.

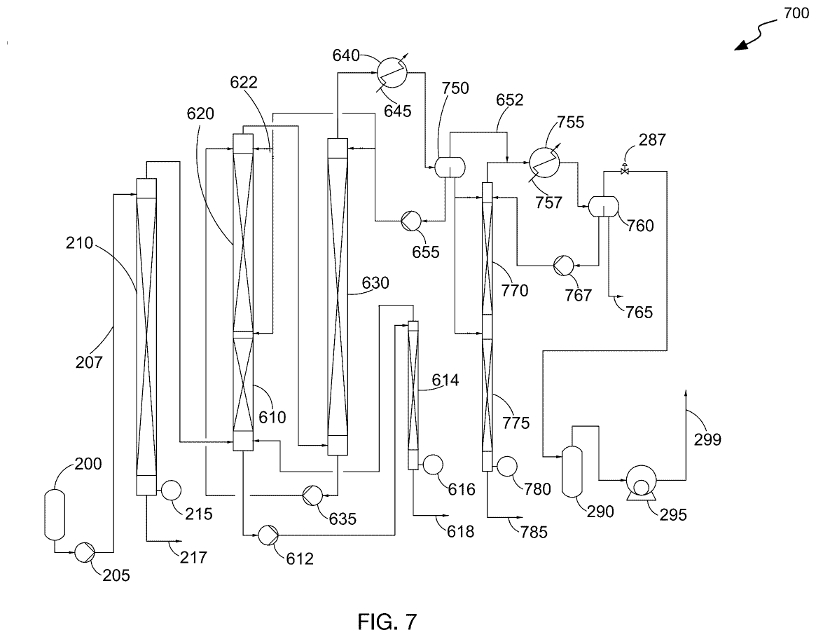

Now referring to FIG. 7, liquid from condenser 640 is collected in separator 750; the liquid that is not returned to column 630 is gravity fed to either column 770 or column 775 diverted with valves at the inlets of the columns. Reboiler 780 provides heat to column 770 and column 775 while desirable liquid product is removed from the system at stream 785. Condenser 755 uses cooling media 757 to condense overhead products of column 770. The liquid from condenser 755 is collected in separator 760 and partially returned to column 770 using pump 767. Light product is removed from the system at stream 765.

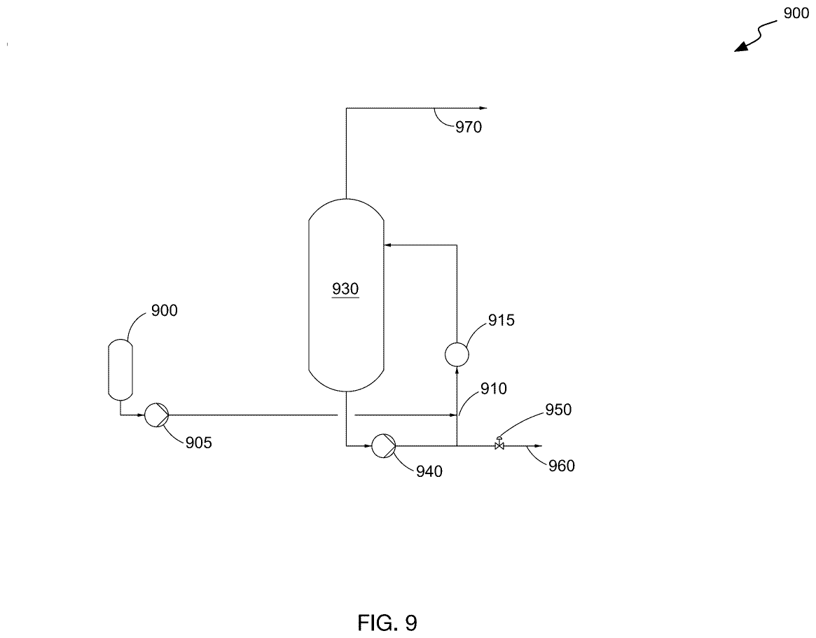

Referring now to FIG. 9, in some embodiments, the stripping section may be arranged in a fashion suitable for the processing of feeds that contain solids. In some instances, feed is moved from feed tank 900 using pump 905 into vessel 930 with a recirculation loop at mixing point 910. The feed may be injected prior to reboiler 915 in the recirculation loop. The recirculation pump 940, is a pump suitable for moving liquid with solids, slurry, or both, circulating the liquid contents of the tank along with the fresh feed through the reboiler and back into the vessel where the returned material has partially vaporized into stream 970. One example of a suitable pump for this embodiment is a flexible impeller pump. The bottoms 960 are removed, for example, a flow control valve 950 and controller on the recirculation loop, by a separate dedicated pump for off-take, or the like. For increased stripping efficiency, two or more of these flash vessels and recirculation loops may be arranged in series.

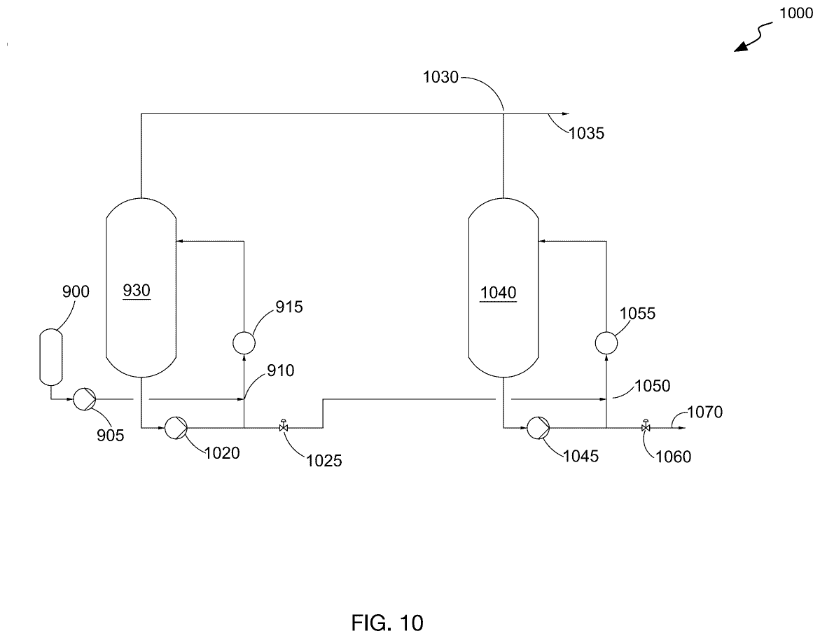

Referring now to FIG. 10, in some embodiments, the bottoms product of the first vessel 930 feeds the next flash stage using pump 1020 and flow control valve 1025. This is mixed with the recirculation loop for flash vessel 1040 a mixing point 1050. Recirculation pump 1045 moves the liquid through the loop that incorporates the reboiler 1055. Overheads product of the second stage evaporator 1040 joins the first stage vapor at mixing point 1030 and is routed as mixed vapor 1035 to further processing in the described rectification and stripping sections. Bottoms product 1070 is taken off at the final flash stage just before fresh feed is introduced to the loop and is controlled by flow control valve 1060. Multiple additional recirculation loops and flash vessels can be incorporated in series to achieve desired stripping alcohol efficiency.

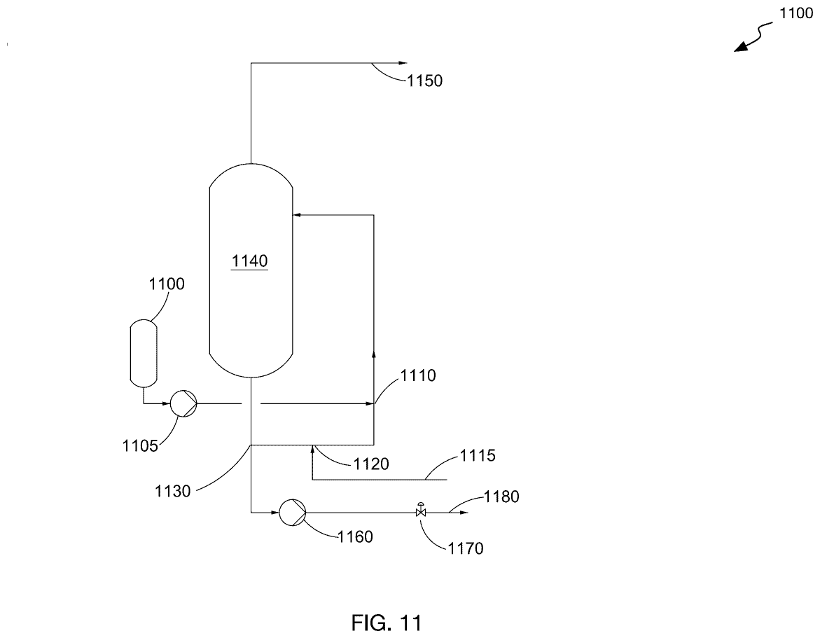

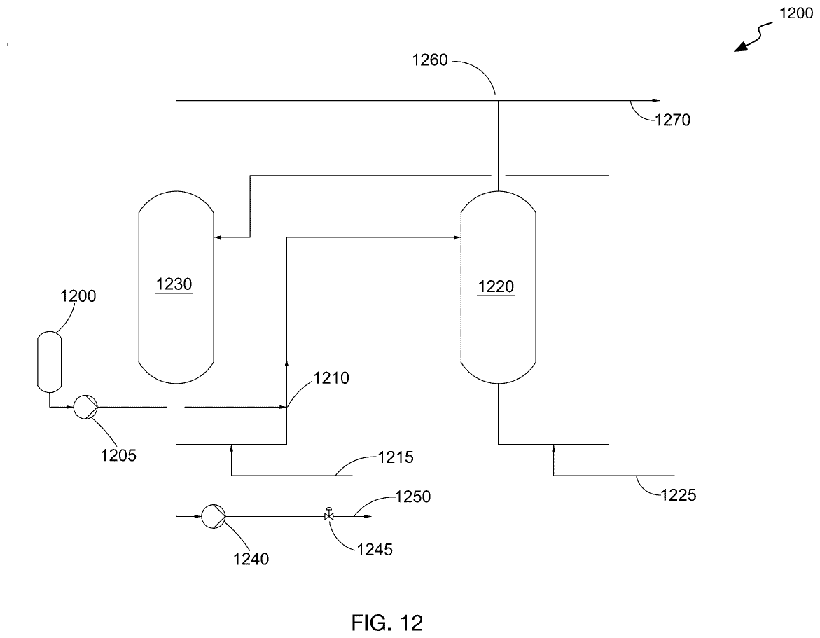

Referring now to FIG. 11 and FIG. 12, in some embodiments, the stripping section may be arranged in a similar fashion with one or more recirculation loops and a flash vessel using live steam injection to facilitate heat and by use of a motive eductor/ejector to provide the liquid flow/recirculation required for the operation of the flash vessel stripping system. Feed from tank 1100 is pumped using pump 1105 into the recirculation loop for flash vessel 1140. Live clean steam 1115 is injected into the recirculation loop at point 1120 upstream of mixing point 1110. Overhead vapors 1150 are routed to the next distillation processing step. Bottoms pump 1160 moves stripped bottoms product 1180 out of the recirculation loop utilizing flow control valve 1170 for rate and/or level control of the system; bottoms removal point 1130 is a connection point for this line. Several stripping vessels can be arranged in series with live steam injection providing heat for the systems as well. Feed from tank 1200 is moved with pump 1205 into a recirculation loop. The loop recirculates contents of the bottoms of the flash vessel 1220 and is mixed with motive live steam 1225 that moves the stream via eductor steam injection and the loop is routed to flash vessel 1230. The bottoms of vessel 1230 may be moved with motive steam 1215 or with an additional recirculation pump. Fresh feed enters at mixing point 1210 and is routed to the next stage. Pump 1240 moves bottoms product 1250 out of the system utilizing flow control valve 1245 for bottoms flow rate and/or level control of the liquid in the system. Additional stages may be added to increase total efficiency of stripping stage product removal. Vapor from the evaporation stages is mixed at point 1260 and moved to the next processing stage as vapor 1270.

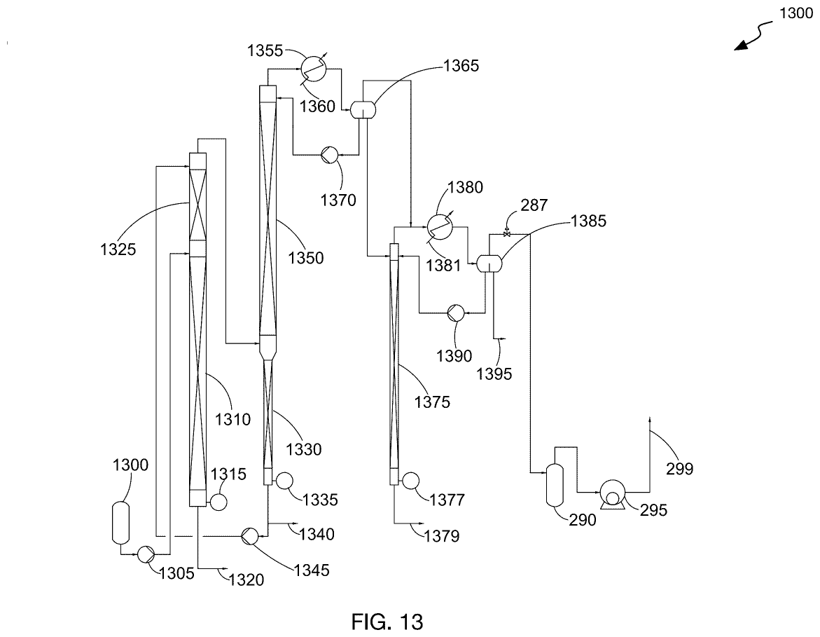

Referring now to FIG. 13, in some embodiments, the stripping column 1310 may be arranged with an additional column section overhead 1325 or setup as a side stripper. This additional section may function as an additional rectification section to provide higher purity ethanol and/or may be utilized to provide a de-foaming mechanism for feeds that have a tendency to foam with injected into a vacuum. Feed from tank 1300 is moved with pump 1305 to the top of the stripping column 1310. Reboiler 1315 provides heat to the stripping column 1310. Liquid reflux from pump 1345 or from an additional condensing heat exchanger installed downstream of the stripping still vapor outlet may be pumped to the top of the column 1325 packing to facilitate the rectification and the de-foaming mechanism. Foam is reduced as the liquid moves down the packing and may prevent or reduce entrained foam from moving downstream in the system which might otherwise result in a need for additional cleaning.

In some embodiments, the rectification column has two packed sections (1350 and 1330); the vapor feed enters the column in between these two sections. The upper section 1350 is sized with a larger diameter to accommodate the higher vapor and liquid rates in this rectification section. The lower section 1330 of the column is sized with a smaller diameter because of the lower liquid rates due, at least in part, to the smaller fraction removed at the bottom of this column. The heavier components of the alcohol and most of the water are removed in this column as a bottoms product 1320. In some instances, water content of the rectified alcohol in the rectification column 1350 is controlled, at least in part, by the reflux rate of the column, stripped vapor content from the first section, and method of operation of the column 1330 section and its reboiler 1335. Tails are removed as the bottoms product 1340 of column 1330 as a controlled amount of the sump liquid is pumped to the top of column section 1325 for use as reflux and/or defoaming liquid. In other instances, if high-efficiency tails removal is not specified, the reboiler 1335 may be eliminated along with the column section 1330. In some embodiments, the rising vapor feed from column 1350 is condensed in condenser 1355. Condenser 1355 can be a heat exchanger that uses glycol, cold water, or other cooling media 1360 to condense the vapors of the overhead product of column 1350. Temperature of the cooling media can be below 55° F., and in some embodiments, is targeted at 30° F. to 40° F. In some instances, lower than typical vacuum operating pressure may involve lower glycol temperature; often the approach temperature of the condenser 1355 can be 20° F. for design (glycol 20° F. below condenser 1350 vapor inlet temperature). In some embodiments, condenser 1350 meets the low pressure drop specification of the vacuum distillation system and the materials of construction requirements. In some instances, total pressure drop is controlled or minimized across the system, such as across the longest vapor flow path, to a specification set to not exceed a set operating temperature of the system. Operating temperature limits can vary. In some instances, targeted temperature ranges are under 100° F. for product processing as some products involve lower processing temperature for maintaining stability. Condensate from condenser 1355 is routed to separator 1365 and liquid reflux is returned to the column 1350 by reflux pump 1370. Remaining condensate is gravity fed to column 1375. Reboiler 1377 provides heat for column 1375; stream 1379 is the bottoms product of the column 1375 and is typically recovered as the desired distillate product. Overhead vapor from column 1375 is condensed in condenser 1380 using cooling media 1381. Liquid from condenser 1380 is collected in separator 1385 Separator 1365 is vented to condenser 1380. Separator 1385 is vented to pressure control valve 287 that regulates vacuum pressure in the system by modulating flow of vapor to vacuum system. Overhead product 1395 is removed from the system. Reflux pump 1390 may move reflux back to column 1375 to control overhead product split if desired. Vacuum pump separator 290 collects any liquid that may accumulate before the vacuum pump 295 routes vapor 299 to the atmosphere. A scrubber may also be employed to reduce outlet volatile or smell of the vapor exiting the vacuum pump.

Referring now to FIG. 6 and FIG. 7, in some embodiments, an additional column 630 (or columns) may be integrated to increase the rectification of the product, reduce the overall installation height requirement, or both. The additional column may be configured as a side stripper with an additional pump 635 or in a vertical arrangement. Liquid from the column 630 bottoms is moved via pump 635 to the top of column section 620 to provide reflux to column 620, 610, or both.

In some embodiments, some non-condensable vapor (gases/vapor present in the liquid feed, CO2, methanol, acetone, and the like) passes through condenser 640 without condensing. The liquid condensate from condenser 640 moves with the fraction of non-condensables into separator 650. Separator 650 can function as a liquid/vapor separator as well as a reflux controller. Separator 650 can be arranged as a horizontal or vertical separation vessel. In some instances, liquid and vapor enter the side inlet of separator 650; vapor and liquid are gravity separated (with the option of adding section of coalescing media, if specified for separation). Liquid collects in the upstream side of the horizontal vessel and is held back from the downstream side by, for example, a weir that is fully welded to seal within the vessel. In some instances, a vertical arrangement, a baffle separates the pump or overflow draws. In other instances, a stand pipe may separate the draws. Pump 655 draws liquid at a controlled rate and moves it as reflux back to the top of column 620. Pump 655 flow is variable and controllable, such control by, for example, a dosing or flow-controlled pump or a flow control valve and flow transmitter. The remainder of the liquid that is not pumped by pump 655 flows over the weir in separator 650 and proceeds to the column 685 (alternatively a stand pipe may be used instead of a baffle, though liquid residence time may be reduced and steady-stream operation may be more easily interrupted).

Now referring to FIG. 9, in some embodiments, vapor from the stripping column is processed through column 610, 620, and 630 for maximum rectification. Pump 635 moves liquid from the sump of column 630 to top of column 620. Pump 612 moves liquid from column 610 bottoms to column 614. Reboiler 616 provides heat to the column 614 and product takeoff 618 removes tails from the process. Reflux valving at point 622 allows for selection of reflux point in order to disable some packing and perform less rectification if desired. Overhead product from column 630 is routed to condenser 640 that uses cooling medium 645 to condense the stream. Condensed liquid is collected in separator 850 and partially returned as reflux by pump 655. Vent line 652 connects the vapor path of separator 850 to the inlet of the condenser 855 that uses cooling medium 857 to condense vapor product from column 870. Column 880 provides vapor to column 870; reboiler 885 and liquid take off 890 are at the bottom of column 880. Pump 875 moves liquid to the top of column 880 from column 870 bottoms. Separator 860 collects liquid from condenser 855 and is vented by pressure control valve 287 that routes vapor to the vacuum system. pump 867 moves reflux from separator 860 to column 870. Liquid reflux from separators 850 and 860 is distributed by way of a liquid distributor suitable for the low liquid rates and high vapor rates required by these sections. Liquid flows down the packing (either structured or random) in the columns as vapor from the reboilers or stripping column rise. The vapor is rectified as it moves up the column, and the fraction of ethanol and lighter components increases. The height of the packed section in columns and reflux ratio (determined by the pumping rate of the reflux pumps, ratio of liquid returned to the columns) determine the amount of rectification and therefore the proof of the distillate product. Returning the liquid at a lower point in the column (or at multiple lower points) can allow the operator to control the proof of the product and manufacture any product proof desired. These lower point liquid reflux returns may be separated by flanged column connections and/or by column internals for proper liquid/vapor distribution.

Reboilers operates using any heating media suitable for the process to input heat and vaporize liquid in the column sumps. Reboilers may be of any arrangement if it they are suited for the vacuum process by not producing excessive back pressure or localized hot temperatures. Natural circulation (thermosyphon) reboilers may work as long as care is taken in design of the systems and their piping. Pumped feed reboilers can be used in order to, at least in part, minimize the temperature rise across the reboiler. The reboilers partially vaporize the liquid bottoms products of columns, and can allow for more alcohol to be recovered in the system when configured as lower active column sections or side strippers. System arrangements with lower alcohol recovery rates can be obtained by eliminating the reboiler and/or these lower column packing areas. Tails and water can be removed from the sump of the rectification column to maintain a steady liquid level in the reboiler by either liquid overflow (weir or other device) or by pump and level control. Columns may also be setup as side strippers (side columns) if height or other requirements are not appropriate to allow packing or column sections to be vertically stacked underneath the vapor inlets and packed column sections.

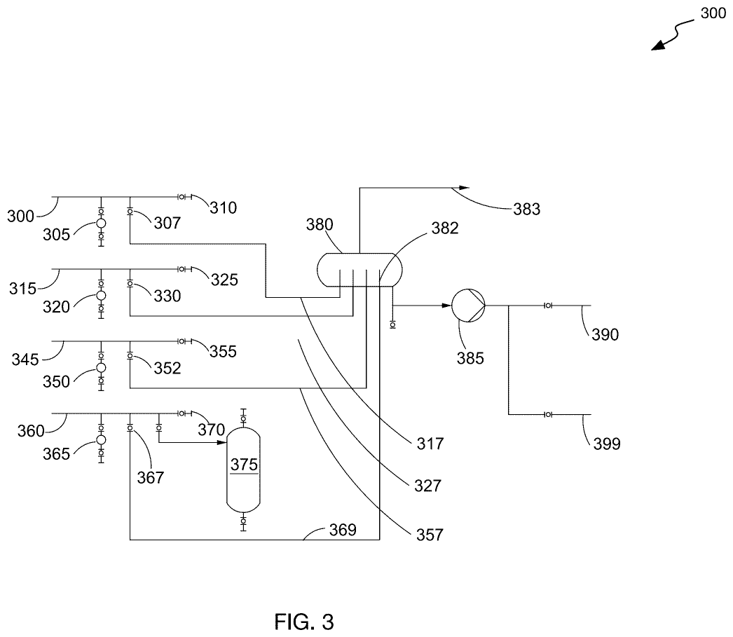

Referring now to FIG. 3, in some instances, tails 315 are routed with the bottoms 300 to the liquid off take system. Either can be sampled in a double block valve arrangement sample port 305 (typically set up with a viewport or other small collection vessel in-between valves) or routed to collection tanks or to a collection vessel for multiple products, which can, at least in part, reduce or minimize equipment and the footprint of the system. The tank 380 for collection of multiple products is set up with standpipes 382 for each bottom inlet connection so that under normal conditions, there is no mixing potential due to backflow. Each tube has a liquid trap extended down (with an optional drain for liquid removal at shutdown) to, at least in part, prevent or reduce vapor from moving through the liquid collection system. Tank 380 is vented where the vent connection 383 may be routed to the vacuum KO tank provided that there is an additional vacuum controller acting on the vent. The tank 380 vent may be routed to the sump of the stripping column or rectification column. The vent recycles an amount of flashing vapor or vapor displaced by liquid moving about the system to the columns that process the vapor. In some instances, the vent may not be connected to the final stripping column sump, as the heavier components would enter the hearts cut and not be separated.

In some embodiments, one or more of the liquid takeoffs (bottoms, tails, hearts, and heads) have plumbing considerations to route the liquid so that it may be sampled, collected in the tank 380 and pumped via pump 385 to recycle 390 (to the feed tank) for process startup, collected in the tank 380 and pumped to storage or disposal 399 (for on-stream operation all but hearts would be routed in this fashion), or collected in auxiliary tanks. Tank 380 may be outfitted with sight gauge(s), level switch(es) for pumping and level control, or level transmitter(s) for pumping and level control. Additional tanks may also be installed in a similar parallel valved fashion to collects hearts product or other products, where it may be isolated by valves and pumped off during operation for quality control of smaller quantities of product. Each pump-off volume of these tanks may be individually evaluated, proofed and approved as desired by the customer per operation and/or product requirements. Double block sample valves with sight glass for viewing are provided upstream of product collection valves and auxiliary connection ports. Port 305, port 320, port 350, port 365 have been outfitted in this fashion with valve 307, valve 330, valve 352, and valve 367 to direct products to the tank 382 if desired. Port 310, port 325, port 355, and port 370 are included for auxiliary connections if pumping or other handling method is desired. Low points in piping are specified for each line and include low point 317, low point 327, low point 357, and low point 369 that serve to prevent vapor flow through these lines due to differential pressure at each tie in point.

In some embodiments, the liquid product that is directed from the separator to the top of a column is distributed at the to onto structured or random packing by a liquid distributor suitable for low liquid rates and high vapor rates required by the process. Reboiler for the final stripping column vaporizes liquid in the column sump and in some instances has the same requirements as the rectification column reboiler. Vapor from the final stripping reboiler moves up the final stripping column and at least partially vaporizes the liquid moving down the column. At least a portion of the lighter components (heads) are stripped into an overhead vapor that leaves the top of the column and is routed to the overhead condenser. In some embodiments, the overhead condenser operates as a full condenser and routes its liquid condensate as well as any minor non-condensables (CO2, methanol, acetone, etc.) to the downstream separator. In some instances, condensers for rectification overheads have the same requirements as the condenser for the final stripping section. The final stripping section condenser can have lower coolant temperature to achieve the minimum approach temperature desired for the heat exchanger and vapor load. The final stripper overhead condenser can be operated at a range below 40° F. in order to reduce the vapor load to the vacuum pump. Considerations can be taken for operation and for cleaning operations of the still when coolant temperature is below 32° F. to not freeze water that could reach the condenser. With lower operating temperature of the final overhead condenser cooling media, more vapor can be condensed and the vapor load to the vacuum pump is reduced. Some deeper vacuum designs may specify a coolant temperature below water freezing temp. In some embodiments, liquid from the final overhead condenser is collected in the downstream separator in the same fashion as the other system separator for rectification column overheads operates. A reflux returns reflux to the final stripping column; arrangements of the system can be fashioned without returning liquid reflux to the final stripping column, though efficiency of the collected alcohol product is reduced.

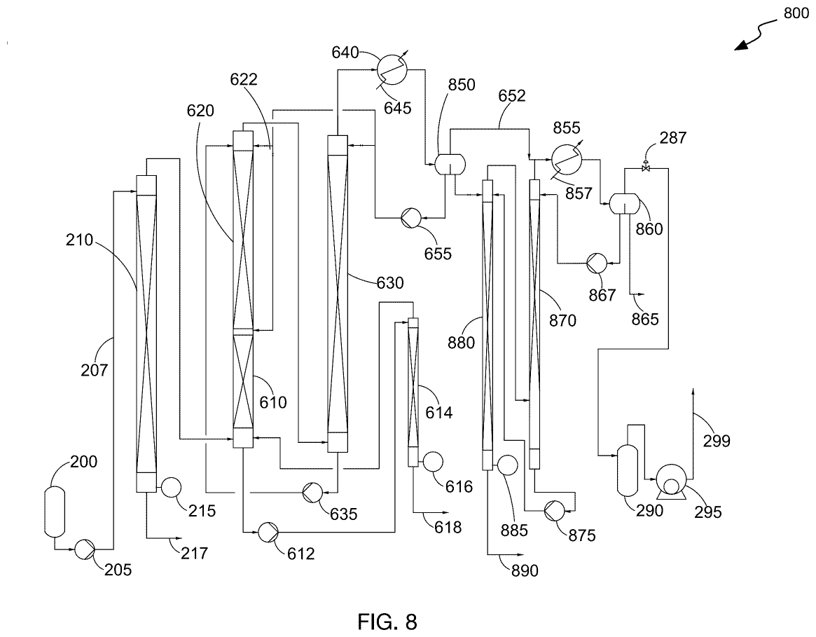

Referring now to FIG. 7 and FIG. 8, in some embodiments, the final stripping column can be divided into 2 packed sections with the liquid from the reflux pump routed to either the lower or the upper section of packing. The reflux from pump 635 is routed to either as well. The upper packing section, column 670 may be sized for larger vapor or liquid rates if increased heads efficiency removal is required for specific product requirements. The addition of this column section as a vertically integrated system to the column or as a side stripper can allow for more separation of ethanol (hearts) from the heads cut being driven overhead in the final stripping column. Column 775 sump liquid consists of desirable product (hearts) at steady-state operation and is taken off by either overflow to the liquid takeoff system or via a pump and level control.

In some embodiments, a control valve is installed on the vent line for separator 760 that controls the flow of vapor into the tank 290 and into the vacuum pump 295. The vacuum KO vessel protects the vacuum pump from liquid that may cause damage on some arrangements of vacuum pump. Many types and arrangements of vacuum pumps may be used for the system, provided they can obtain the flow demands for pump down of the system and total flow levels that maintain vacuum in the system. Total for vacuum pump flow rating is the sum of leakage rate for the system and non-condensable flow. Non-condensable flow rate can vary with feed type and pressure of the system, as well as feed temperature. Vacuum pump discharge/exhaust can be routed either to the atmosphere, a scrubber, to other equipment depending on installation requirements.

In some embodiments, typical control of the system includes the following. Reboiler for first stripping column heat input rate is at a sufficient level to drive all desirable alcohol overhead into vapor product. To startup the system and achieve steady state operation, the system is run at a desired feed rate and heat input to the first reboiler is adjusted (or alternatively live steam injection adjusted) while testing bottoms product until desirable bottoms product is achieved. Desirable bottoms product will often have ninety-eight percent or more of the alcohol removed and is often tested in a lab still. In some instances, if the feed is well known, a temperature value for the liquid in the stripping column reboiler may be sufficient or nearly sufficient to determine the amount of alcohol remaining in the bottoms. With the feed vapor liquid equilibria data, using the system operating pressure and reboiler liquid operating temperature, alcohol content of the bottoms may be determined satisfactorily, and heat input rate may be adjusted accordingly.

Rectification reboiler heat input can be sufficient to drive desirable alcohol back into rectification section (if applicable for system arrangement); excessive reboiler heat input can drive unwanted heavier (tails) products overhead and into downstream columns and hearts product. Rectification column reflux rate can be adjusted by adjusting the reflux pump rate. Higher proof products can involve a reflux rate of 3:1 or higher for separation. Liquid reflux return position into the rectification column can be set before the run is started according to target product specifications. If applicable, the reflux return position to the column can determine which column sections are active for the rectification of the ethanol product. In some embodiments, these columns may be set up with auxiliary ports/connections to facilitate the removal and addition of packing into the column for various products. Packing depth and type may be quickly changed to suit product or processing requirements. Column sections that do not have liquid reflux flowing will not be active and will not provide rectification of the product. Having lower rectification of the product will reduce product output proof and is desirable for some distillate products. In some embodiments, insulation of the rectification section can reduce or eliminate condensation of vapor inside the columns on the column walls if the ambient temperature is colder than that of the operational temperature inside the column.

Final stripping column heat input rate can determine the amount of lights driven overhead and into ‘heads’ cut. The sampling of reboiler liquid offtake product and sensory or laboratory evaluation can determine if desired power, and therefore the product, is obtained. Reflux rate (if applicable per arrangement of system) can be adjusted by altering the reflux pump pumping rate, where more reflux can increase efficiency of separation. In some instances, the column can be run with no reflux by not operating the reflux pump. This can reduce utility loads but may allow more desirable product into the heads cut. In another arrangement with an additional column packed section or side stripper, the reflux rate, reboiler heat input rate, and point of liquid feed (to upper or lower column section) from the overhead separator can control column performance and product. Liquid or vapor temps are monitored throughout the system and can be used to adjust heat input rates or reflux rates during operation. The system can be designed to operate continuously or near-continuously at steady-state once input parameters are set and desired product parameters are reached. Recipes or production parameters may be stored in the control system and saved for future use or reference.

By manipulating one or more control variable of one or more stages of the system independently, the hearts product characteristics may be partially or fully controlled and separated according to the desired operation. Feed rate and heat rate of the first stripping column reboiler can control the stripping section's output and efficiency of alcohol removal from the feed. Heat rate of reboiler for the rectification column (if applicable), reflux rate to the rectification column, reflux position (controlling which column loads are active), the type of packing (characteristics determining HETP, height of each theoretical plate), and packing depth of active columns can determine the amount of rectification and cut of the spirit moving downstream to the last section for processing. Higher rectification column reboiler heat rates, less active packing or packing with higher HETP, and lower reflux operating ratio from the reflux pump will reduce purity of the rectified product and allow more heavy components to remain in the product. The lights removal section may be controlled by the final stripping column reboiler heat input rate, and the injection point for liquid from the rectification section if applicable.

Cleaning of the system can be performed after shutdown and draining. Hot water, cold water, or cleaning chemical solutions, alone or in combination, can be pumped through piping to the tops of columns and injected using spray balls. Columns may be isolated so that liquid fills and soaks internals.

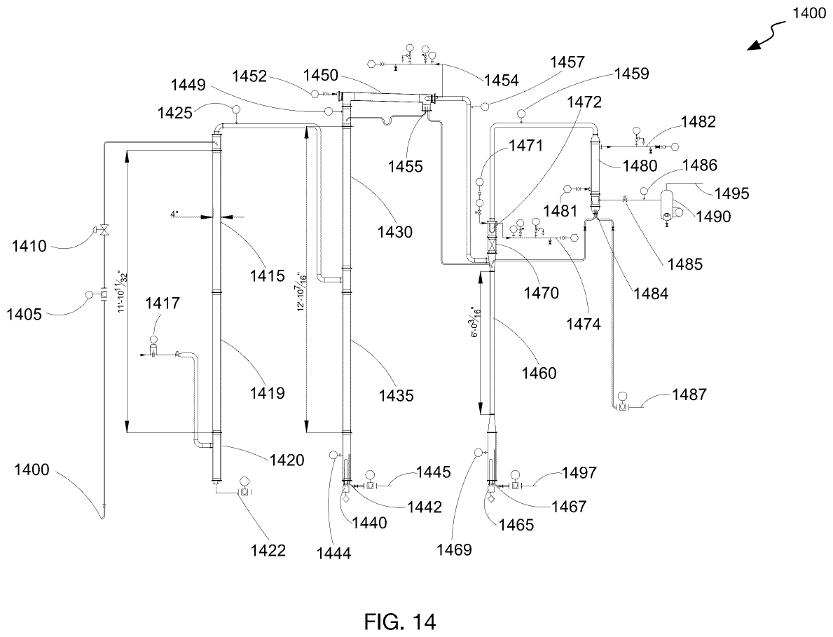

Now referring to FIG. 14, this drawing shows an arrangement of an embodiment with feed line 1400. Feed is metered through a flow transmitter 1405 through control valve 1410 into the upper section of the stripping column, column 1415. Clean steam is metered through flow transmitter and control valve arrangement 1417 into the sump 1420 of the stripping column and into the lower column 1419. Bottoms are removed from the system via line 1422. Temperature is monitored remotely using temperature transmitter 1425 in the vapor path of the column 1415 overheads. This vapor is routed to a connecting column section between column 1430 and column 1435. Heat may be applied to column 1435 using reboiler 1440. Liquid temp in the reboiler is monitored using temperature transmitter 1444. Standpipe 1442 controls the level of the reboiler as liquid moves out through line 1455 that is equipped with a flow transmitter. Top column temperature is monitored using temperature transmitter 1449. Column 1430 overheads are routed to condenser 1450 and cooled using chilled glycol supplied from line 1452. Glycol return line 1454 includes temperature indication, pressure indication, and a pressure safety valve. Pressure transmitter 1457 monitors pressure at the outlet of condenser 1450. Reflux controller 1455 distributes liquid received from condenser 1450 into a reflux line and a line that feeds column 1460; orifices in the standpipes of the reflux controller allow for controlled reflux split in the reflux controller. Reboiler 1465 provides heat for column 1460 and temperature transmitter 1469 allows monitoring of the reboiler temperature. Standpipe 1467 removes liquid from the sump and transfers it to stream 1497 that is equipped with a flow transmitter. Column 1470 receives vapor from column 1460 and liquid from reflux heat exchanger 1472 that is designed as a partial condenser utilizing glycol supply 1471 and glycol return 1474. Overheads are routed to condenser 1480 that utilizes glycol supply 1481 and glycol return 1482 for cooling. Reflux controller 1484 splits the condensed overheads into a reflux stream and a take-off stream 1487 that is equipped with a flow transmitter. Pressure control valve 1485 controls vapor flow and a PID controller regulates system pressure utilizing pressure transmitter 1459 to read the process pressure. Temperature transmitter 1486 monitors vacuum vapor temperature and is utilized to act as an alarm if temperature exceeds the setpoint, for instance, if cooling was suddenly lost. Separator vessel 1490 acts as a separator for any liquid that is in the vacuum line before it can reach the vacuum pump through line 1495.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of this disclosure.

What is claimed is:

1. A continuous vacuum distillation system for separating one or more components of a multi-component composition by distillation, the system comprising:
(i) a plurality of distillation columns comprising a stripping column and a rectification column, wherein at least a portion of the plurality of distillation columns are configured according to an indirect split arrangement of the coupled sections;
(ii) a plurality of condensers;
(iii) a plurality of separators;
(iv) a packing;
(v) a plurality of liquid distributors;
(vi) a plurality of reflux controllers;
(vii) a pressure sensor control;
(viii) a vacuum pressure control valve operable to maintain a near steady-state pressure condition;
(ix) a feed;
(x) a feed pipe;
(xi) a feed flowmeter;
(xii) a feed control valve positioned downstream of the feed flowmeter; and
(xiii) a pressure sensor proximal to the furthest downstream condenser inlet.

2. The continuous vacuum distillation system of claim 1 further comprising a stripping column reboiler.

3. The continuous vacuum distillation system of claim 1 further comprising a feed pump.

4. The continuous vacuum distillation system of claim 1 wherein the near steady-state pressure condition comprises an absolute pressure operating range of approximately 25 mmHg to 55 mmHg.

5. The continuous vacuum distillation system of claim 1 wherein the near steady-state pressure condition comprises an absolute pressure operating range of approximately 15 mmHg to 85 mmHg.

6. The continuous vacuum distillation system of claim 1 wherein the reboiler operates at a temperature at or below 110° F.

7. The continuous vacuum distillation system of claim 1 wherein the pressure sensor control is integrated with the vacuum pressure control valve operable to stop processing under leak conditions.

8. The continuous vacuum distillation system of claim 1 wherein the continuous vacuum distillation system further comprises a closed system.

9. The continuous vacuum distillation system of claim 1 wherein the continuous vacuum distillation system further comprises an operating temperature less than 100° F.

10. The continuous vacuum distillation system of claim 1 wherein the continuous vacuum distillation system further comprises an operating temperature between 70° F. and 100° F.

11. The continuous vacuum distillation system of claim 1 wherein the feed comprises a temperature within 10° F. of a top operating temperature of the stripping column.

12. The continuous vacuum distillation system of claim 1 wherein the feed comprises a temperature within 2° F. of a top operating temperature of the stripping column.

13. The continuous vacuum distillation system of claim 1 further comprising a near steady-state condition, wherein the near steady-state condition comprises a nearly unchanged pressure condition across a plurality of stages.

14. The continuous vacuum distillation system of claim 2 wherein the stripping column reboiler comprises a stab-in reboiler.

15. The continuous vacuum distillation system of claim 2 wherein the stripping column reboiler comprises a low watt density heater element.

16. The continuous vacuum distillation system of claim 2 wherein the low watt density heater element comprises a wattage less than 150 Watts/inch².

17. The continuous vacuum distillation system of claim 2 wherein the low watt density heater element comprises a wattage less than 50 Watts/inch².
